(19) United States
(12) Patent Application Publication
(10) Pub. No.: US 2016/0297026 A1
(43) Pub. Date: Oct. 13, 2016

(54) ENGINE DRIVEN WELDER WITH LEVER FOR POLARITY AND OUTPUT RANGE

(71) Applicant: LINCOLN GLOBAL, INC., CITY OF INDUSTRY, CA (US)

(72) Inventor: EDWARD A. ENYEDY, EASTLAKE, OH (US)

(21) Appl. No.: 14/685,049

(22) Filed: Apr. 13, 2015

(51) Int. Cl. B23K 9/10

(52) U.S. Cl. CPC B23K 9/1006; B23K 9/1043

(57) ABSTRACT

The invention described herein generally pertains to a system and method for a motor-driven welder assembly including a motor that is a power source that supplies a power output for the welding device or an equipment electrically coupled to the welding device; a mechanical lever that is moveable between two or more pre-defined locations, wherein each of the two or more pre-defined locations is associated with a type of a welding operation that corresponds to the power output for the welding operation and a polarity for the power output; and a user interface, on an exterior surface of the welding device, that is configured to display data and includes a label for each of the two or more pre-defined locations, wherein the label conveys the type of the welding operation, the power output for the welding operation, and the polarity for the power output.

### TECHNICAL FIELD

The invention described herein pertains generally to a system and method for an engine driven welder that performs one or more welding operations, wherein the one or more welding operations include respective polarities for a power output.

### BACKGROUND OF THE INVENTION

Frequently, welding is required where supply power may not be readily available. As such, the welding power supply may be an engine driven welding power supply incorporating a generator. The generator may supply power to the welder as well as to other power tools as may be needed on site. As different applications require different versions of welders and power tools, the trailer may be designed to carry one of many different types of welding power supplies.

Traditional welding-type apparatus can be broken into two basic categories. The first category receives operational power from transmission power receptacles, also known as static power. The second is portable or self-sufficient, stand alone welders having internal combustion engines, also known as rotating power. While in many settings conventional static power driven welders are preferred, engine driven welders enable welding-type processes where static power is not available. Rotating power driven welders operate by utilizing power generated from engine operation. As such, engine driven welders and welding-type apparatus allow portability and thus fill an important need.

A welding device can include a myriad of settings, configurations, and adjustments for each of the numerous welding operations performed.

### SUMMARY OF THE INVENTION

In accordance with the present invention, there is provided a welding device that includes a motor-driven welder assembly including a motor that is a power source that supplies a power output for the welding device or an equipment electrically coupled to the welding device; a mechanical lever that is moveable between two or more pre-defined locations, wherein each of the two or more pre-defined locations is associated with a type of a welding operation that corresponds to the power output for the welding operation and a polarity for the power output; a user interface, on an exterior surface of the welding device, that is configured to display data and includes a label for each of the two or more pre-defined locations, wherein the label conveys the type of the welding operation, the power output for the welding operation, and the polarity for the power output.

In accordance with the present invention, there is provided a welding device that includes a user interface. The user interface can include at least the following: a display, on an exterior of the welding device, that is configured to render a portion of a graphic related to a set of control settings for the welding device to perform one or more welding operations, wherein the one or more welding operations is a MIG welding operation, a TIG welding operation, a stick welding operation, or an FCAW welding operation; a mechanical lever that is moveable between two or more pre-defined locations designated by respective notches, wherein each of the two or more pre-defined locations indicates the set of control settings for the welding device; the set of control settings are the one or more welding operations, the power output for the one or more welding operations, and a polarity for the power output for the one or more welding operations; the set of control settings includes the following: a first set of control settings for metal inert gas, with the power output for metal inert gas is one of a range of 18 volts to 28 volts with a positive polarity or a range of 14 volts to 22 volts with a positive polarity; a second set of control settings for stick, wherein the power output for stick is one of 80 amperes with a negative polarity, 80 amperes with a positive polarity, 130 amperes with a positive polarity, 180 amperes with a positive polarity, or 250 amperes with a positive polarity; a third set of control settings for tungsten inert gas, wherein the power output for tungsten inert gas is one of 80 amperes with a negative polarity, 80 amperes with a positive polarity, 130 amperes with a positive polarity, or 180 amperes with a positive polarity; and a fourth set of control settings for flux cored arc welding, wherein the power output for flux cored arc welding is one of a range of 18 volts to 28 volts with a negative polarity or a range of 14 volts to 22 volts with a negative polarity.

In accordance with the present invention, there is provided a welding device that includes at least the following: a motor-driven welder assembly including a motor that is a power source that supplies a power output for the welding device or an equipment electrically coupled to the welding device; the welding device is configured to perform one or more welding operations, wherein the one or more welding operation is a MIG, a TIG, a stick positive, or an FCAW; a mechanical lever that is moveable between two or more pre-defined locations, wherein each of the two or more pre-defined locations indicates control settings for the welding device, the control settings are the one or more welding operations, the power output for the one or more welding operations, and a polarity for the power output for the one or more welding operations; and a user interface, on an exterior surface of the welding device, that is configured to convey data and includes a label for each of the two or more pre-defined locations, wherein the label conveys the one or more welding operations, the power output for the one or more welding operations, and the polarity for the power output for the one or more welding operations.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 is a diagram illustrating a welding device that includes a motor as a power source;

FIG. 2 is a diagram illustrating a welding device;

FIG. 3 is a diagram illustrating a welding device affixed to a trailer for mobility;

FIG. 4A is a diagram illustrating a welding device;

FIG. 4B is a diagram illustrating a welding device;

FIG. 5A is a diagram illustrating a welding device that includes a mechanical lever and a user interface that restricts a polarity selection based on a type of a welding operation selected;

FIG. 5B is a diagram illustrating a mechanical lever and a user interface that restricts a polarity selection based on a type of a welding operation selected;

FIG. 6 is a diagram illustrating a mechanical lever and a user interface that restricts a polarity selection based on a type of a welding operation selected;

FIG. 7 is a diagram illustrating a mechanical lever and a user interface that restricts a polarity selection based on a type of a welding operation selected;

FIG. 8A is a diagram illustrating a mechanical lever that is used with a welding device in accordance with the subject innovation; and

FIG. 8B is a diagram illustrating a mechanical lever that is used with a welding device in accordance with the subject innovation.

### DETAILED DESCRIPTION OF THE INVENTION

Embodiments of the invention relate to methods and systems that generally relate to a welding device and, in particular, a hybrid welding device, that utilizes a mechanical lever and a user interface that restricts a polarity setting dependent upon a type of a welding operation selected, wherein the restriction prevents incorrect polarity or power output settings for the welding device for the type of welding operation. In particular, the welding device can include a mechanical lever that is moveable between pre-defined locations which correspond to a power output, a polarity, and a type of a welding operation. The welding device can include a user interface that displays information related to the type of the welding operation, the power output, and the polarity. In an embodiment, the user interface can be on an exterior face or side of the welding device.

Conventionally, the operator sets the desired output range with one switch and the process polarity with another switch. These conventional and inferior two-switch techniques allow for incorrect and potentially dangerous results for the welding device when an output range is selected with an incorrect process polarity. The subject innovation overcomes these deficiencies by using a mechanical lever and a user interface that restrict user input to a pre-defined pairings of 1) type of welding operation selection; and 2) corresponding polarity for the type of welding operation selected.

For instance, Metal Inert Gas (MIG) and flux cored procedures are constant voltage processes. MIG is usually electrode positive while most self-shielded flux cored wires are electrode negative. Most stick welding is electrode positive. Tungsten Inert Gas (TIG) welding is commonly electrode negative, though AC is popular when welding aluminum and some use electrode positive procedures on thin material. The subject innovation restricts user input and prevents incorrect adjustment of settings for the welding device.

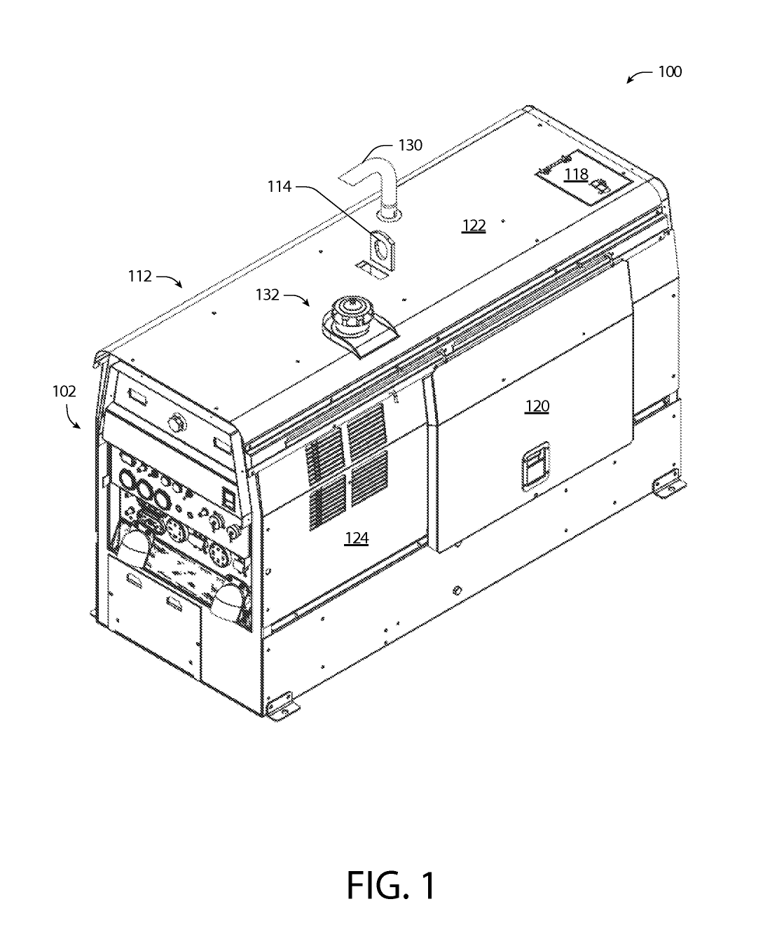

The subject innovation can be used with any suitable engine-driven welder, engine-driven welding system, engine-driven welding apparatus, a welding system powered by an engine, a welding system powered by a battery, a welding system powered by an energy storage device, a hybrid welder (e.g., a welding device that includes an engine driven power source and an energy storage device or batter), or a combination thereof. It is to be appreciated that any suitable system, device, or apparatus that can perform a welding operation can be used with the subject innovation and such can be chosen with sound engineering judgment without departing from the intended scope of coverage of the embodiments of the subject invention. The engine driven welder can include a power source that can be used in a variety of applications where outlet power is not available or when outlet power will not be relied on as the sole source of power including portable power generation, backup power generation, heating, plasma cutting, welding, and gouging. The example discussed herein relates to welding operations, such as, arc welding, plasma cutting, and gouging operations. It is to be appreciated that a power source can generate a portion of power, wherein the portion of power is electrical power. It is to be appreciated that “power source” as used herein can be a motor, an engine, a generator, an energy storage device, a battery, a component that creates electrical power, a rotor/stator assembly, a component that converts electrical power, or a combination thereof. By way of example and not limitation, FIGS. 1-4 illustrate welding systems or devices that can be utilized with the subject innovation. It is to be appreciated that the following welding systems are described for exemplary purposes only and are not limiting on the welding systems that can utilize the subject innovation or variations thereof.

FIG. 1 illustrates a welding device 100 having a user interface 102. The user interface 102 can be configured to display information related to the welding device 100 and/or receive input or settings to control the welding device 102. The user interface can include analog components and/or digital components such as buttons, dials, triggers, switches, displays, and the like. The user interface 102 can be located on, for instance, an exterior side or an exterior panel of the welding device 100. However, in another embodiment, the user interface 102 can be located behind a cover, or access door. In still another example, the user interface 102 can be a separate component that communicates with the welding device 100 via a wired communication or wireless communication. For instance, a tablet or portable device (e.g., smartphone, laptop, wearable device, personal computer, computer, watch device, helmet device, smart glasses, portable digital assistant, etc.) can be a remote or wired user interface to control one or more welding devices 100.

The welding device 100 includes a housing 112 which encloses the internal components of the welding device. Optionally, the welding type device 100 includes a loading eyehook 114 and/or fork recesses 116. The loading eyehook 114 and the fork recesses 116 facilitate the portability of the welding device 100. Optionally, the welding-type device 100 could include a handle and/or wheels as a means of device mobility. The housing 112 also includes a plurality of access panels 118, 120. Access panel 118 provides access to a top panel 122 of housing 112 while access panel 120 provides access to a side panel 124 of housing 112. A similar access panel is available on an opposite side. These access panels 118, 120, provide access to the internal components of the welding device 100 including, for example, an energy storage device suitable for providing welding-type power. An end panel 126 includes a louvered opening 128 to allow for air flow through the housing 112.

The housing 112 of the welding-type device 100 also houses an internal combustion engine. The engine is evidenced by an exhaust port 130 and a fuel port 132 that protrude through the housing 112. The exhaust port 130 extends above the top panel 122 of the housing 112 and directs exhaust emissions away from the welding-type device 100. The fuel port 132 preferably does not extend beyond the top panel 122 or side panel 124. Such a construction protects the fuel port 132 from damage during transportation and operation of the welding-type device 100.

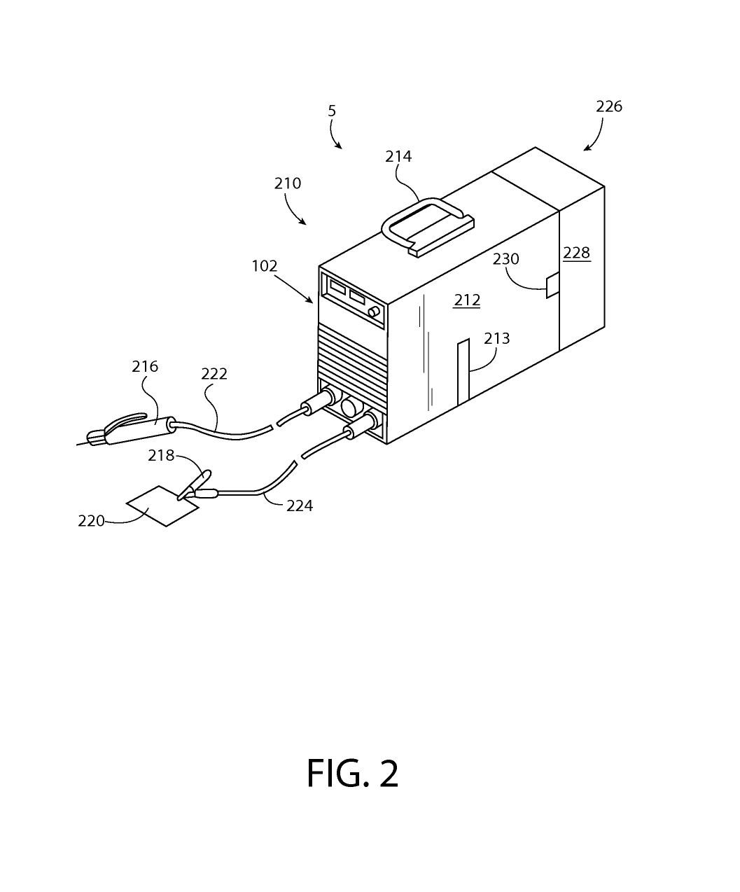

Referring now to FIG. 2, a perspective view of a welding apparatus 205 that can be utilized with the subject innovation. Welding apparatus 205 includes a power source 210 that includes a housing 212 enclosing the internal components of power source 210. As will be described in greater detail below, housing 212 encloses control components 213. Optionally, welding device 210 includes a handle 214 for transporting the welding system from one location to another. To effectuate the welding process, welding device 210 includes a torch 216 as well as a grounding clamp 218. Grounding clamp 218 is configured to ground a workpiece 220 to be welded. As is known, when torch 216 is in relative proximity to workpiece 220, a welding arc or cutting arc, depending upon the particular welding-type device, is produced. Connecting torch 216 and grounding clamp 218 to housing 212 is a pair of cables 222 and 224, respectively.

The welding arc or cutting arc is generated by the power source by conditioning raw power received from an interchangeable energy storage device 226. In a preferred embodiment, energy storage device 226 is a battery. Energy storage device 226 is interchangeable with similarly configured batteries. Specifically, energy storage device 226 is encased in a housing 228. Housing 228 is securable to the housing of welding device 210 thereby forming welding-type apparatus 205. Specifically, energy storage device 226 is secured to power source 210 by way of a fastening means 230. It is contemplated that fastening means 230 may include a clip, locking tab, or other means to allow energy storage device 226 to be repeatedly secured and released from power source 210.

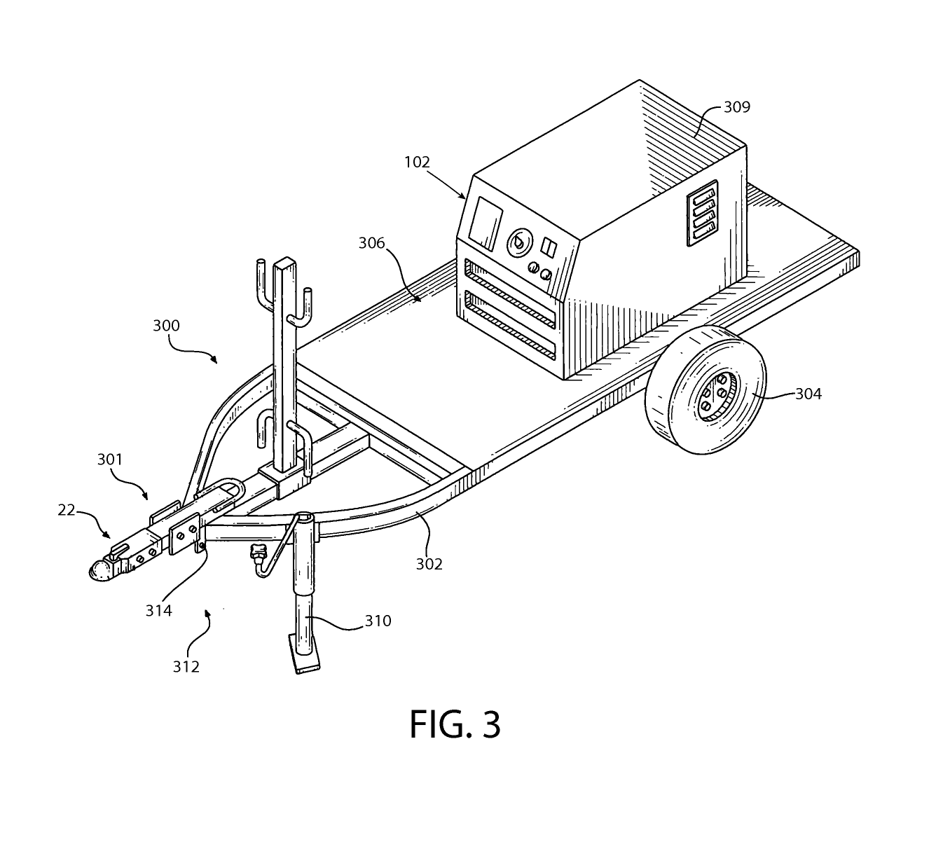

FIG. 3 illustrates a trailer 300 incorporating a trailer hitch or hitching device, depicted generally at 301. The trailer 300 may include a trailer frame 302 and one or more trailer wheels 304 in rotational connection with the trailer frame 302 and may further include a payload region 306 for carrying one or more cargo items, which in an exemplary manner may be a welding power supply 309 or an engine driven welding power supply 309. The trailer 300 may also include an adjustable stand 310 for adjusting the height of the front end 312 of the trailer 300. However, any means may be used for raising and/or lowering the front end 312 of the trailer 300. The trailer hitch 301 may be a generally longitudinal and substantially rigid trailer hitch 301 and may be attached to the frame 302 via fasteners 314, which may be threaded bolts.

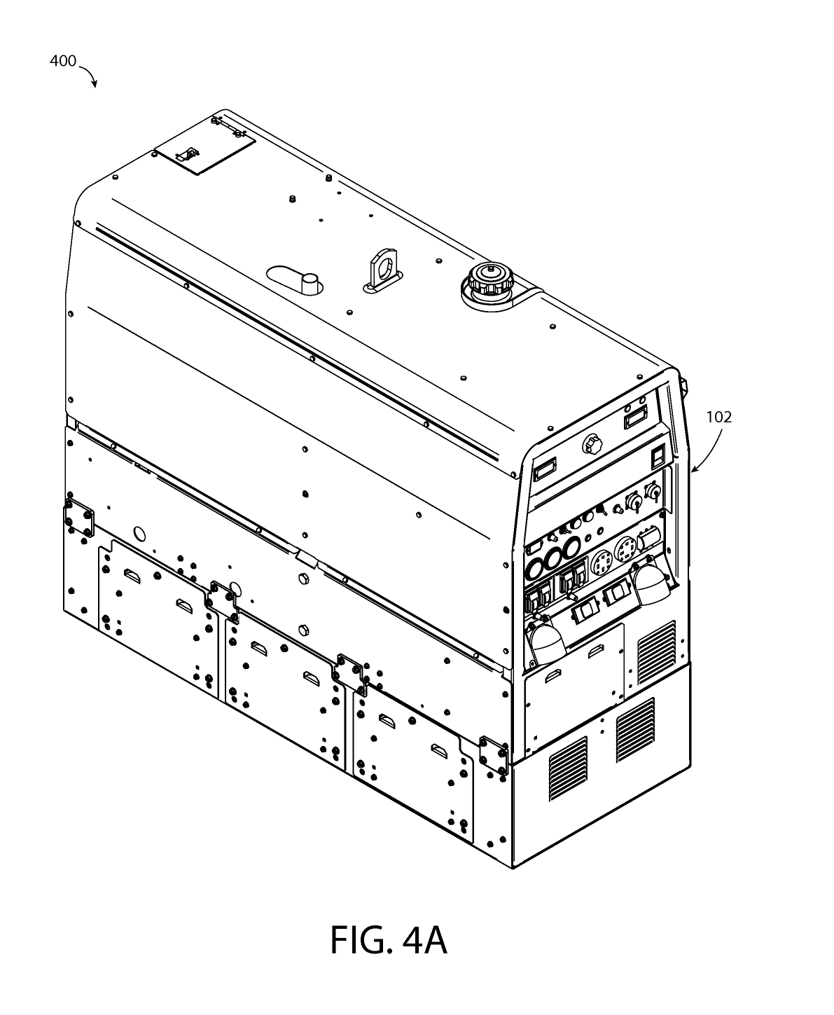

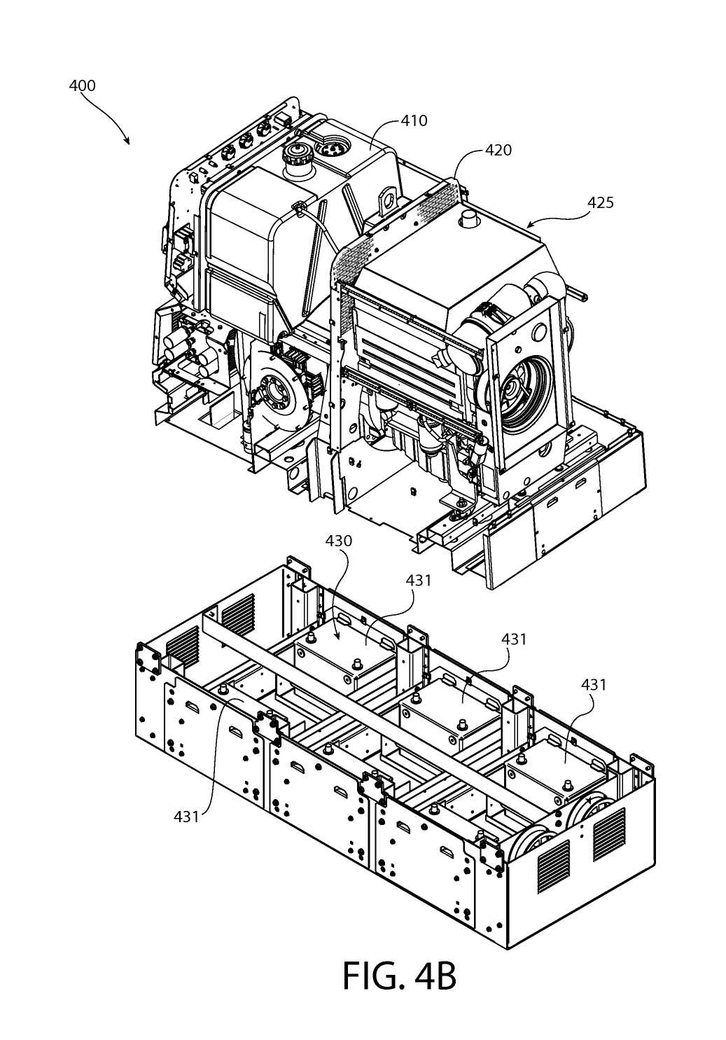

FIGS. 4A and 4B illustrate a hybrid welding device (herein referred to as a “hybrid welder”). A hybrid welder according to the invention is generally indicated by the number 400 in the drawings. Hybrid welder 400 includes an engine component that runs on fuel from fuel storage 410 allowing the hybrid welder 400 to be portable. It will be appreciated that hybrid welder 400 may also be mounted in a permanent location depending on the application. Hybrid welder 400 generally includes a motor-driven welder assembly 420 having a motor 425 and an energy storage device 430. Motor 425 may be an internal combustion engine operating on any known fuel including but not limited to gasoline, diesel, ethanol, natural gas, hydrogen, and the like. These examples are not limiting as other motors or fuels may be used.

The motor 425 and energy storage device 430 may be operated individually or in tandem to provide electricity for the welding operation and any auxiliary operations performed by hybrid welder 400. For example, individual operation may include operating the motor 425 and supplementing the power from the motor 425 with power from the energy storage device 430 on an as needed basis. Or supplying power from the energy storage device 430 alone when the motor 425 is offline. Tandem operation may also include combining power from motor 425 and energy storage device 430 to obtain a desired power output. According to one aspect of the invention, a welder 400 may be provided with a motor having less power output than ordinarily needed, and energy storage device 430 used to supplement the power output to raise it to the desired power output level. In an embodiment, a motor with no more than 19 kW (25 hp) output may be selected and supplemented with six 12 volt batteries. Other combinations of motor output may be used and supplemented with more or less power from energy storage device. The above example, therefore, is not limiting.

Energy storage device 430 may be any alternative power source including a secondary generator, kinetic energy recovery system, or, as shown, one or more batteries 431. In an embodiment, six 12 volt batteries 431 are wired in series to provide power in connection with motor-driven welder assembly 420. Batteries 431 shown are lead acid batteries. Other types of batteries may be used including but not limited to NiCd, molten salt, NiZn, NiMH, Li-ion, gel, dry cell, absorbed glass mat, and the like.

In an embodiment, the welding device 100 can include a hybrid power source that includes motor component and energy storage device. It is to be appreciated that the hybrid power source can be substantially similar to the hybrid device discussed above in FIGS. 4A and 4B. For instance, a motor can generate a voltage and such voltage can be stored in an energy storage device. A switch component or controller can automatically select between motor and energy storage device for a power source for the welding operation performed by the welding device 400. In an embodiment, the switch component can select between motor and energy storage device based upon a welding parameter.

For instance, the welding parameter can be, but is not limited to, a voltage of the welding operation, a current of the welding operation, a portion of a waveform used with the welding operation, a welding schedule parameter (e.g., welding process, wire type, wire size, wire feed speed (WFS), volts, trim, wire feeder to use, feed head to use, among others), a position of a welding tool, a composition of the workpiece on which the welding operation is performed, a position or location of an operator, sensor data (e.g., video camera, image capture, thermal imaging device, heat sensing camera, temperature sensor, among others), an amount of fuel available for motor, an amount of charge stored in energy storage device, a signal from a controller of the welding operation, a signal from a controller associated with welding device, and the like.

By way of example and not limitation, the welding parameter can be, but is not limited to, a type of welding operation, a type of shielding gas, a material composition of workpiece W, a welding pattern, a type of electrode, a composition of electrode, a wire feed speed, a waveform used for the welding operation, a polarity of a welding wire, a type of flux, a number of electrodes used in the welding operation, an arc voltage, a travel speed of a tractor welder that performs the welding operation, an arc current level, a height of torch, a distance between workpiece W and torch, an oscillation width of electrode, a temperature of welding wire, a temperature of electrode, a type of material of workpiece W, a frequency of oscillation of electrode, a polarity of the arc current, a polarity of the current for welding wire, a parameter that affects an arc current of the welding operation, a gauge of wire, a material of wire, oscillation dwell, left oscillation dwell, right oscillation dwell, any and all variation of advanced process controls (e.g., move controls, pulse-frequency, ramp rates, background level ratios, etc.), and the like.

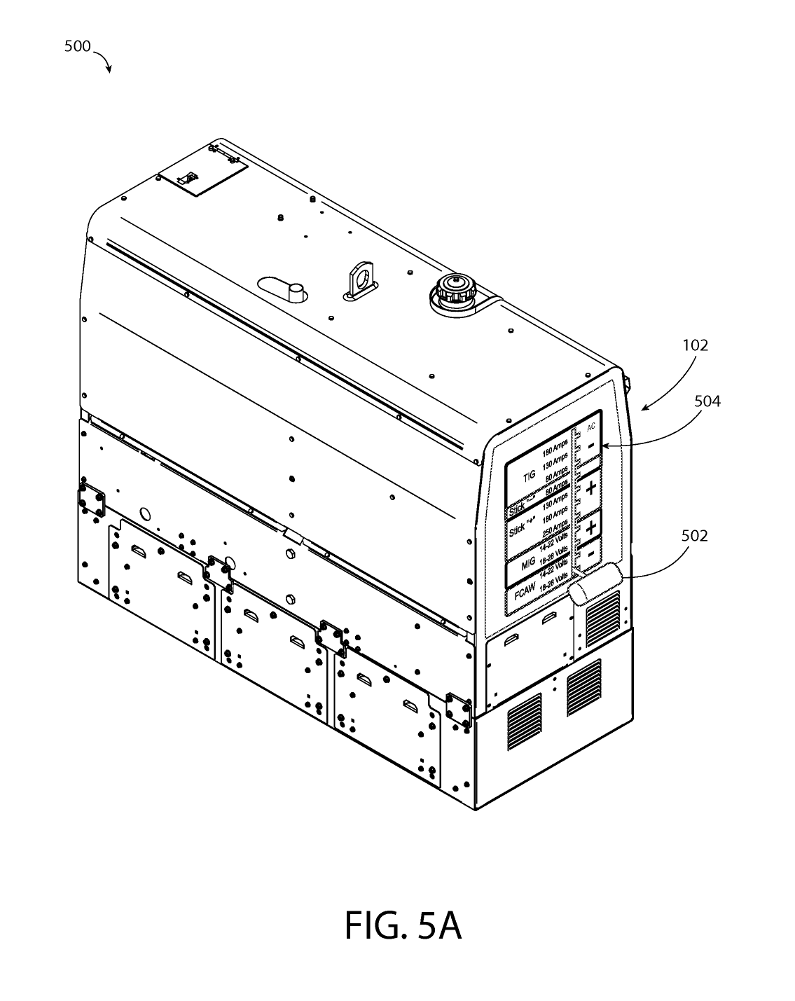

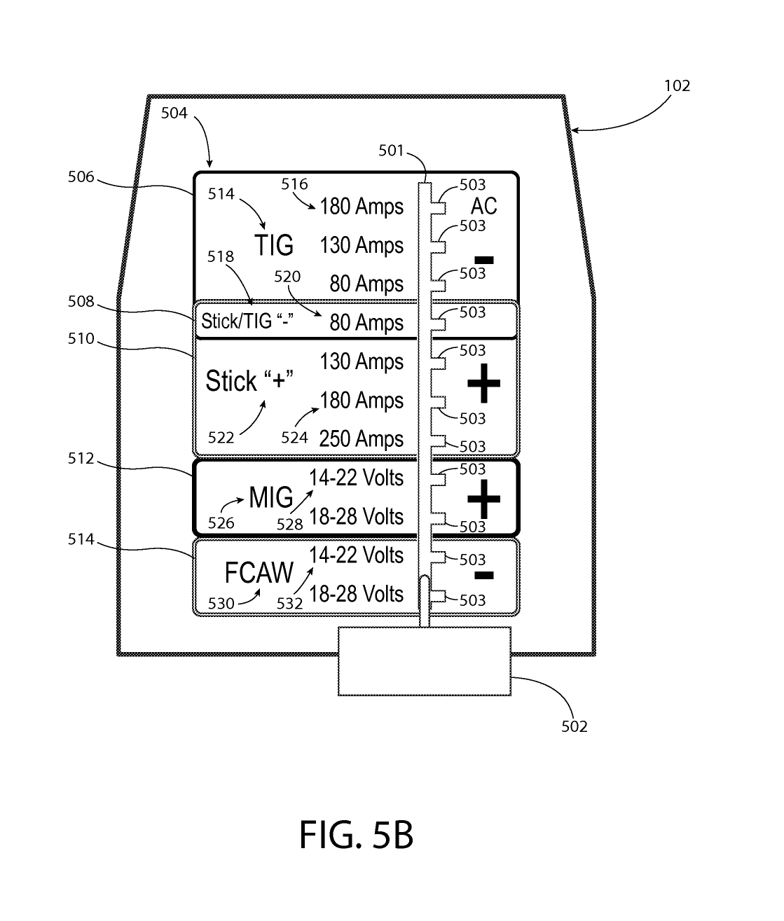

The best mode for carrying out the invention will now be described for the purposes of illustrating the best mode known to the applicant at the time of the filing of this patent application. The examples and figures are illustrative only and not meant to limit the invention, which is measured by the scope and spirit of the claims. Referring now to the drawings, wherein the showings are for the purpose of illustrating an exemplary embodiment of the invention only and not for the purpose of limiting same, FIGS. 5-8 illustrate a schematic block diagram of a welding device, and in particular, an engine driven welding device as discussed in FIGS. 1-4.

Turning to FIG. 5A, a welding device or system 500 is illustrated that includes a mechanical lever 502 and a user interface 102 that restricts a polarity selection based on a type of a welding operation selected. FIG. 5A illustrates a first configuration 504 of the user interface 102. The user interface 102 can be located on an exterior of the welding device 100. In another embodiment, the user interface 102 can be behind a cover or an access door. In general, the user interface 102 can be positioned such that a user can access the user interface 102 to provide input or receive data (e.g., read data or a display). The user interface 102 can be a label, a sticker, or a digital screen/display, wherein each can convey information. The user interface 102 displays data and can receive data input via the user.

In particular, the mechanical lever 502 can be moveable between pre-defined locations in which a pre-defined location corresponds to 1) a type of a welding operation; 2) a power output; and 3) a polarity of the type of welding operation and the power output. The pre-defined locations prevent incorrect selection of welding settings. In an embodiment, the mechanical lever 502 can be moveable within a guide with one or more notches that correspond to the pre-determined settings defined for such pre-defined location.

In an embodiment, the mechanical lever 502 can be a lever with a shaft and a handle. In another example, the mechanical lever 502 can be coupled to a multi-pole contact switch of which the mechanical lever selects between such contacts. In such example, each contact can correspond to a polarity and type of welding operation indicated by the user interface.

In another embodiment, the mechanical lever 502 can be one or more buttons or switches for each notch or pre-defined location, wherein only one button or switch can be activated or selected.

FIG. 5B illustrates the first configuration 504 that can be employed as the user interface 102 for the welding device 100. The first configuration can include the mechanical lever 502 and the user interface 102 to restrict a polarity selection based on a type of a welding operation selected. Mechanical lever 502 can be moveable between pre-defined locations through a guide 501, wherein the guide 501 can include one or more notches 503. It is to be appreciated and understood that each notch can be respective to a defined power output for a type of welding operation at a polarity. The first configuration 504 can include the user interface 102 having a name or reference to indicate at least one of the following: a type of welding operation; a power output for the type of welding operation; and a polarity.

In an embodiment illustrated in FIG. 5B, the first configuration 504 of the user interface 102 can include the following type of welding operations: 1) Tungsten Inert Gas (TIG); 2) Stick “−”; 3) Stick “+”; 4) Metal Inert Gas (MIG); and 5) Flux Cored Arc Welding (FCAW).

The guide 503 is illustrated as having a substantially straight orientation having one or more notches 503 on the right side. However, it is to be appreciated that the guide can be of various shapes or configurations and the notches 503 can be oriented off the guide 501 in various manners. In a particular example, the notches 503 can be on the left side. In a particular example, the notches 503 can be on both the right side and the left side. In another embodiment, the guide 501 can be oriented in a horizontal position rather than the vertical position as illustrated, wherein the notches 503 can be positioned above and/or below the guide 501. In another embodiment, the guide 501 can include curves, corners, angles, and the like.

For each type of welding operation, a pre-determined power output and polarity can be defined, wherein a notch 503 can designate such setting for the welding device 100. The first configuration 504 of the user interface 102 can be arranged such that one or more regions 506, 508, 510, 512, and 514 correspond to a type of a welding operation and within the region for each type of a welding operation, a power output and polarity is defined. The mechanical lever 502 can be positioned within one or more notches 503 that correspond to a region and thus a type of welding operation at a power output with a polarity, wherein the setting for the type of welding operation is pre-defined. It is to be appreciated that the region(s) can be positioned in various fashion as illustrated with the first configuration 504 and other configurations illustrated in the subject innovation.

In the first configuration 504 of the user interface 102, there can be a region 506 for TIG, having a name or reference “TIG” 514 with power outputs 516.

For instance, the welding device can include the first configuration 504 for the user interface 102 providing a type of welding operation being TIG with power outputs of at least one of 180 amps with a negative polarity, 130 amps with a negative polarity, 80 amps with a negative polarity, 80 amps with a positive polarity, among others.

In the first configuration 504 of the user interface 102, there can be a region 508 for Stick/TIG “−”, having a name or reference “Stick/TIG ‘−’” 518 with power outputs 520.

In another instance, the welding device 100 can include the first configuration 504 for the user interface 102 providing a type of welding operation being Stick “−” with power output of at least 80 amps with a negative polarity, 130 amps with a negative polarity, among others.

In the first configuration 504 of the user interface 102, there can be a region 510 for Stick “+”, having a name or reference “Stick ‘+’” 522 with power outputs 524.

In another instance, the welding device 100 can include the first configuration 504 for the user interface 102 providing a type of welding operation being Stick “+” with power outputs of at least one of 130 amps with a positive polarity, 180 amps with a positive polarity, 250 amps with a positive polarity, among others.

In the first configuration 504 of the user interface 102, there can be a region 512 for MIG, having a name or reference “MIG” 526 with power outputs 528.

In another instance, the welding device 100 can include the first configuration 504 for the user interface 102 providing a type of welding operation being MIG with power outputs of at least one of 12-22 Volts with positive polarity, 18-28 volts with positive polarity, among others.

In the first configuration 504 of the user interface 102, there can be a region 514 for MIG, having a name or reference “FCAW” 530 with power outputs 532.

In another instance, the welding device 100 can include the first configuration 504 for the user interface 102 providing a type of welding operation being FCAW with power outputs of at least one of 12-22 Volts with negative polarity, 18-28 volts with negative polarity, among others.

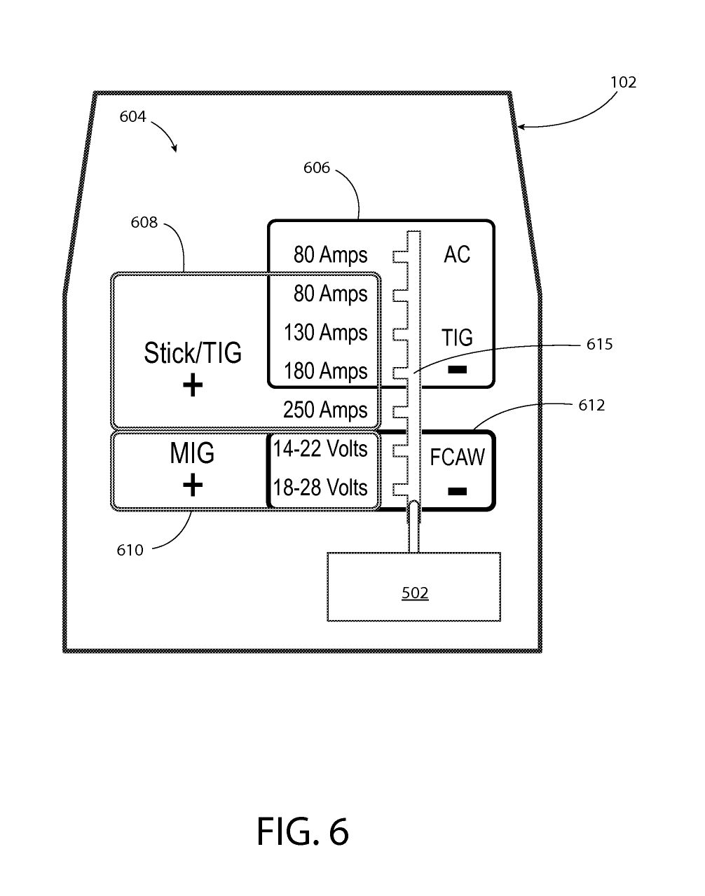

FIG. 6 illustrates a second configuration 604 that can be employed as the user interface 102 for the welding device 100. The second configuration 604 can include regions for TIG 606, Stick/TIG 608, MIG 610, and FCAW 612. As illustrated, the mechanical lever 502 can be positioned in one or more positions via notches 503 to restrict the welding device to particular settings for a type of welding operation. For instance, if the mechanical lever 502 is positioned at reference numeral 615, the welding device 100 can be restricted to one of 1) a type of welding operation being TIG at 180 amps with a negative polarity; 2) a type of welding operation being TIG at 180 amps with a positive polarity; or 3) a type of welding operation being Stick at 180 amps with a positive polarity. In other words, it is to be appreciated and understood that a region defined can correspond to one or more type of welding operation having respective settings (e.g., power output, polarity, etc.). It is to be appreciated that the welding device 100 utilizing the second configuration 604 for the user interface 102 can include a display and/or input to select between the available options when the mechanical lever 502 is in a position that restricts the settings for the welding device 100.

In particular, the second configuration 604 for the user interface 102 can include a type of welding operation being Stick having power output of at least 80 amps with positive polarity, 130 amps with positive polarity, 180 amps with positive polarity, 250 amps with positive polarity, 80 amps with negative polarity, 130 amps with negative polarity, 180 amps with negative polarity, among others.

The second configuration 604 for the user interface 102 can further include a type of welding operation being TIG having power output of at least 80 amps with positive polarity, 130 amps with positive polarity, 180 amps with positive polarity, 250 amps with positive polarity, 80 amps with negative polarity, 130 amps with negative polarity, 180 amps with negative polarity, among others.

The second configuration 604 for the user interface 102 can include a type of welding operation being MIG having power output of at least 14-22 volts with positive polarity, 18-28 volts with positive polarity, among others.

The second configuration 604 for the user interface 102 can include a type of welding operation being FCAW having power output of at least 14-22 volts with negative polarity, 18-28 volts with negative polarity, among others.

In an embodiment, the mechanical lever 502 can include an additional notch for an unrestricted mode which can allow a user to input any setting for a type of welding operation. Thus, this additional notch can be for experienced users and may be used to select a type of welding operation with a manually defined power output and a manually defined polarity. The additional notch can be locked or unlocked to prevent inexperienced users from accessing such freedom of configuration of the welding device 100.

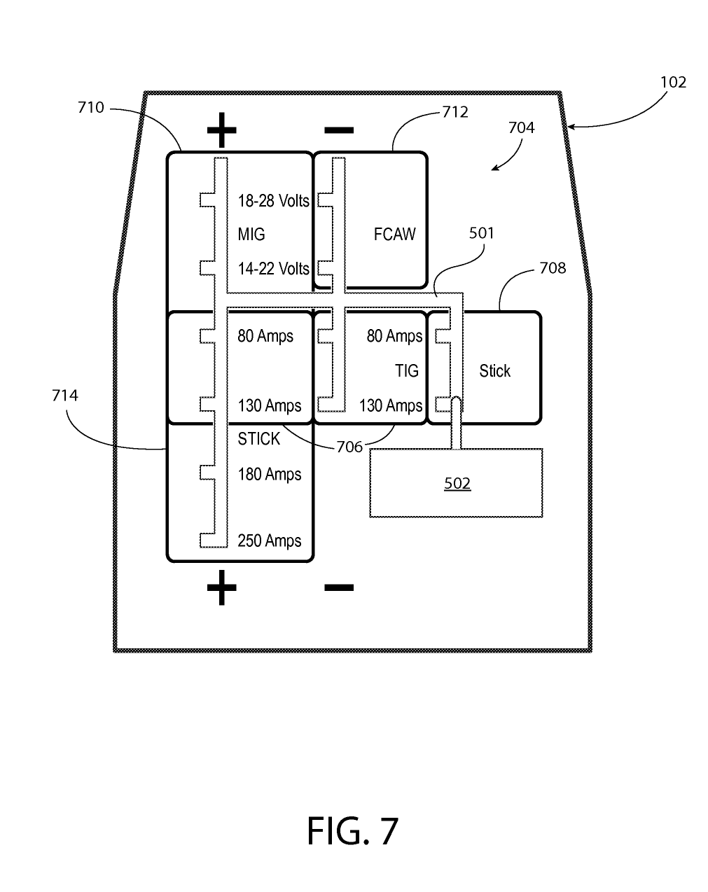

FIG. 7 illustrates a third configuration 704 that can be employed as the user interface 102 for the welding device 100. The third configuration 704 can include a side of the user interface 102 that is designated for positive polarity and a side that is designated for negative polarity, wherein the mechanical lever 502 is moveable within the guide 501 between each side and within notches 503 for each type of welding operation having respective settings.

The user interface 102 in the third configuration 704 can include a region for TIG 706 in a negative polarity for 80 amps and 130 amps. The region for TIG 706 can further include a positive polarity for 80 amps and 130 amps.

The region for Stick 708 and 714 can include a positive portion with notches and a negative portion with notches. The positive portion for Stick 714 can include 80 amps with positive polarity, 130 amps with positive polarity, 180 amps with positive polarity, and 250 amps with positive polarity. The negative portion for Stick 708 can include 80 amps with negative polarity and 130 amps with negative polarity.

The third configuration 704 can include a region for MIG 710 with notches for positive polarity at 18-22 volts and 14-22 volts. A region can be provided for FCAW 712 in a negative polarity with 18-28 volts and 14-22 volts. A region can be provided for Stick 714 with notches for positive polarity at 80 amps, 130 amps, 180 amps, and 150 amps.

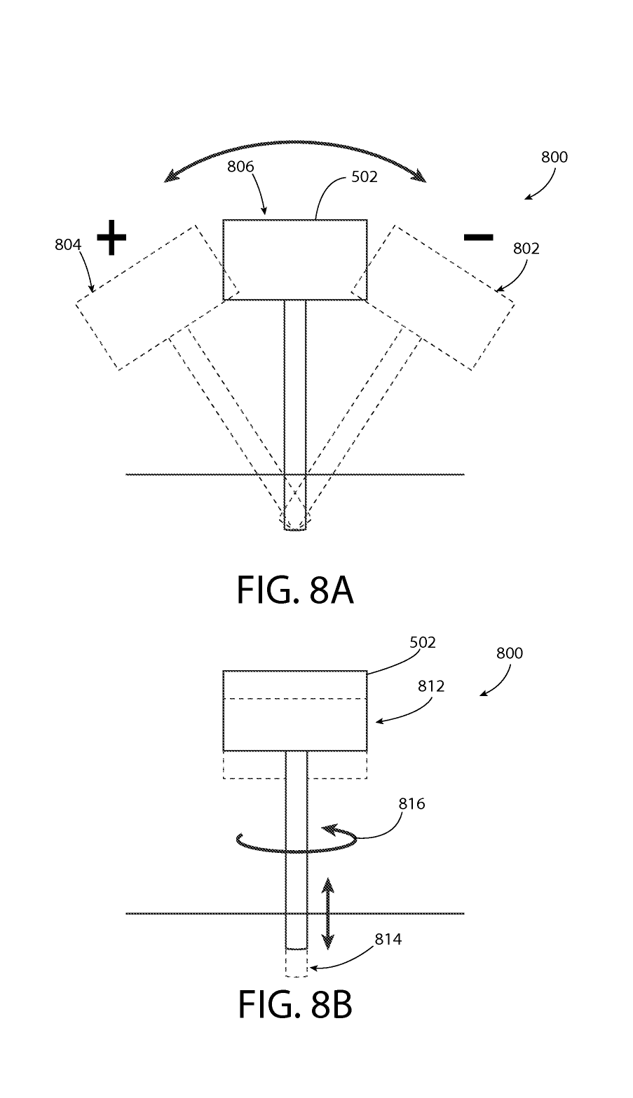

FIGS. 8A and 8B illustrate the mechanical lever 502 that is used with the welding device 100 in accordance with the subject innovation. The mechanical lever 502, as discussed above, can be moveable within a guide to pre-defined locations designated by notches. In another embodiment, the mechanical lever 502 can be moveable in other configurations. For example, the mechanical lever 502, as discussed above, is moveable in a first plane within the guide. Yet, it is to be appreciated that the mechanical lever 502 can be moveable in more than one plane, and in particular, moveable in various degrees of motion. The below are descriptions of embodiments for motion of the mechanical lever 502. Such descriptions can be utilized with the user interface 102 and in particular at least one of the first configuration 504, the second configuration 604, the third configuration 704, among others.

Turning to FIG. 8A, the mechanical lever 502 is illustrated at a side view 800. The mechanical lever 502 can be configured to provide a tilt motion. The tilt motion can allow the mechanical lever 502 to have a range of motion between the angles of about −45 degrees (illustrated at 804) to about 45 degrees (illustrated at 802), wherein the range of motion can provide a number of positions. For instance, the mechanical lever 502 can have three (3) positions, a first position at −45 degrees illustrated at 804, a second position at 90 degrees illustrated at 806, and a third position at 45 degrees illustrated at 802. Each position can be designated for a polarity for example. In particular, the mechanical lever 502 can be moveable within the guide to select a type of welding operation when in the second position (e.g., 90 degrees). Once within a notch or designation of a type of welding operation, the tilt motion can designate a polarity and/or a power output. In this example, the tilt to the first position designates a positive polarity and a tile to the third position designates a negative polarity.

Turning to FIG. 8B, the mechanical lever is illustrated at a side view 810 to describe an additional motion. The lever 502 can be moveable downward and/or upward for additional positions which can designate one or more settings (e.g., type of welding operation, power output, polarity, etc.) for the welding device 100. The mechanical lever 502 can be twisted in a direction (e.g., clockwise, counterclockwise) to a first position and a second position, wherein each of the first position and the second position correspond to a setting (e.g., polarity, etc.). In another embodiment, the lever 502 can move upward and/or downward between positions which can designate a setting for the welding device 100. For example, the lever 502 can be in a first position 812 and pressed downward to a second position 814, wherein the first position and the second position can correspond to a setting for the welding device 100. In another embodiment, the lever 502 can have a first position 812, a second position 814 when pressed downward, and a third position when pulled upward, wherein each position can correspond to a setting or output for the welding device 100.

In an alternative form, motion of the lever 502 in one direction can designate or set a weld power output, and motion in another direction can designate or set polarity. For example, moving the lever 502 up and down (relative to the exterior surface for example) may set output. Twisting the handle of the lever 502 or pushing the handle of the lever 502 in/out may set polarity. This results in a switch or lever 502 with fewer output settings and advantageous to the welder device 100 that has many different output and processes choices.

Yet another improvement is to have a mechanism on the lever 502 that prevents movement until a button is pressed. When the button is pressed, weld output is disabled so that the switches (switches to which the lever 502 makes contact) do not make/break weld output and get damaged. The button may interrupt switching current to a field of an elder/generator, a silicon controlled rectifier (SCR), or other electronic device.

In an embodiment, the welding device can include an energy storage device that is an additional power source for the welding device or the equipment electrically coupled to the welding device and a switch component that selects between the energy storage device and the motor based on a welding parameter.

In the embodiment, the welding parameter is at least one of the type of the welding operation, the power output of the welding operation, or the polarity for the power output.

In an embodiment, a label is displayed electronically on the user interface or on a screen affixed to the user interface. In the embodiment, the label is displayed physically and affixed to the user interface.

In an embodiment, the welding device can include a controller that is configured to restrict a setting of the welding device based on the mechanical lever being positioned in one of the two or more pre-defined locations. In the embodiment, the setting is one of a voltage, a negative polarity of the power output, a positive polarity of the power output, an amperage, or a wire feed speed.

In an embodiment, the exterior surface lies in a first plane and the mechanical lever is moveable in the first plane with a first movement. In an embodiment, the mechanical lever is further configured to be moveable in a second plane with a second movement, wherein the second plane is at least one of the following: parallel to the first plane; orthogonal to the first plane; or non-orthogonal to the first plane. In the embodiment, the first movement corresponds to the type of the welding operation and the second movement corresponds to the polarity for the power output for the type of the welding operation.

In an embodiment, the type of the welding operation is metal inert gas, the power output for the welding operation is one of a range of 18 volts to 28 volts or a range of 14 volts to 22 volts, and the polarity for the power output is positive.

In an embodiment, the type of the welding operation is stick and the power output for the welding operation is one of 80 amperes with a negative polarity, 80 amperes with a positive polarity, 130 amperes with a positive polarity, 180 amperes with a positive polarity, or 250 amperes with a positive polarity.

In an embodiment, the type of the welding operation is tungsten inert gas and the power output for the welding operation is one of 80 amperes with a negative polarity, 80 amperes with a positive polarity, 130 amperes with a positive polarity, or 180 amperes with a positive polarity.

In an embodiment, the type of the welding operation is flux cored arc welding, the power output for the welding operation is one of a range of 18 volts to 28 volts or a range of 14 volts to 22 volts, and the polarity for the power output is negative.

While the embodiments discussed herein have been related to the systems and methods discussed above, these embodiments are intended to be exemplary and are not intended to limit the applicability of these embodiments to only those discussions set forth herein. The control systems and methodologies discussed herein are equally applicable to, and can be utilized in, systems and methods related to arc welding, laser welding, brazing, soldering, plasma cutting, waterjet cutting, laser cutting, and any other systems or methods using similar control methodology, without departing from the spirit or scope of the above discussed inventions. The embodiments and discussions herein can be readily incorporated into any of these systems and methodologies by those of skill in the art. By way of example and not limitation, a power supply as used herein (e.g., welding power supply, among others) can be a power supply for a device that performs welding, arc welding, laser welding, brazing, soldering, plasma cutting, waterjet cutting, laser cutting, among others. Thus, one of sound engineering and judgment can choose power supplies other than a welding power supply departing from the intended scope of coverage of the embodiments of the subject invention.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition, although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A welding device, that includes:
a motor-driven welder assembly including a motor that is a power source that supplies a power output for the welding device or an equipment electrically coupled to the welding device;
a mechanical lever that is moveable between two or more pre-defined locations, wherein each of the two or more pre-defined locations is associated with a type of a welding operation that corresponds to the power output for the welding operation and a polarity for the power output; and
a user interface, on an exterior surface of the welding device, that is configured to display data and includes a label for each of the two or more pre-defined locations, wherein the label conveys the type of the welding operation, the power output for the welding operation, and the polarity for the power output.

2. The welding device of claim 1, further comprising:
an energy storage device that is an additional power source for the welding device or the equipment electrically coupled to the welding device; and
a switch component that selects between the energy storage device and the motor based on a welding parameter.

3. The welding device of claim 2, wherein the welding parameter is at least one of the type of the welding operation, the power output of the welding operation, or the polarity for the power output.

4. The welding device of claim 2, wherein the label is displayed electronically on the user interface or on a screen affixed to the user interface.

5. The welding device of claim 2, wherein the label is displayed physically and affixed to the user interface.

6. The welding device of claim 2, further comprising a controller that is configured to restrict a setting of the welding device based on the mechanical lever being positioned in one of the two or more pre-defined locations.

7. The welding device of claim 6, wherein the setting is one of a voltage, a negative polarity of the power output, a positive polarity of the power output, an amperage, or a wire feed speed.

8. The welding device of claim 2, further comprising the exterior surface that lies in a first plane and the mechanical lever is moveable in the first plane with a first movement.

9. The welding device of claim 8, wherein the mechanical lever is further configured to be moveable in a second plane with a second movement, wherein the second plane is at least one of the following: parallel to the first plane; orthogonal to the first plane; or non-orthogonal to the first plane.

10. The welding device of claim 9, further comprising:
the first movement corresponds to the type of the welding operation; and
the second movement corresponds to the polarity for the power output for the type of the welding operation.

11. The welding device of claim 2, further comprising:
the type of the welding operation is metal inert gas;
the power output for the welding operation is one of a range of 18 volts to 28 volts or a range of 14 volts to 22 volts; and
the polarity for the power output is positive.

12. The welding device of claim 2, further comprising:
the type of the welding operation is stick; and
the power output for the welding operation is one of 80 amperes with a negative polarity, 80 amperes with a positive polarity, 130 amperes with a positive polarity, 180 amperes with a positive polarity, or 250 amperes with a positive polarity.

13. The welding device of claim 2, further comprising:
the type of the welding operation is tungsten inert gas; and
the power output for the welding operation is one of 80 amperes with a negative polarity, 80 amperes with a positive polarity, 130 amperes with a positive polarity, or 180 amperes with a positive polarity.

14. The welding device of claim 2, further comprising:
the type of the welding operation is flux cored arc welding;
the power output for the welding operation is one of a range of 18 volts to 28 volts or a range of 14 volts to 22 volts; and
the polarity for the power output is negative.

15. A user interface for a welding device, comprising:
a display, on an exterior of the welding device, that is configured to render a portion of a graphic related to a set of control settings for the welding device to perform one or more welding operations, wherein the one or more welding operations is a MIG welding operation, a TIG welding operation, a stick welding operation, or an FCAW welding operation;
a mechanical lever that is moveable between two or more pre-defined locations designated by respective notches, wherein each of the two or more pre-defined locations indicates the set of control settings for the welding device;
the set of control settings are the one or more welding operations, the power output for the one or more welding operations, and a polarity for the power output for the one or more welding operations;
the set of control settings includes the following:
a first set of control settings for metal inert gas, with the power output for metal inert gas is one of a range of 18 volts to 28 volts with a positive polarity or a range of 14 volts to 22 volts with a positive polarity;
a second set of control settings for stick, wherein the power output for stick is one of 80 amperes with a negative polarity, 80 amperes with a positive polarity, 130 amperes with a positive polarity, 180 amperes with a positive polarity, or 250 amperes with a positive polarity;
a third set of control settings for tungsten inert gas, wherein the power output for tungsten inert gas is one of 80 amperes with a negative polarity, 80 amperes with a positive polarity, 130 amperes with a positive polarity, or 180 amperes with a positive polarity; and
a fourth set of control settings for flux cored arc welding, wherein the power output for flux cored arc welding is one of a range of 18 volts to 28 volts with a negative polarity or a range of 14 volts to 22 volts with a negative polarity.

16. The user interface for the welding device of claim 15, further comprising a controller that is configured to restrict a setting of the welding device based on the mechanical lever being positioned in one of the two or more pre-defined locations.

17. The welding device of claim 16, wherein the setting is one of a voltage, a negative polarity of the power output, a positive polarity of the power output, an amperage, or a wire feed speed.

18. The welding device of claim 15, further comprising:
the exterior surface lies in a first plane and the mechanical lever is moveable in the first plane with a first movement; and
the mechanical lever is further configured to be moveable in a second plane with a second movement, wherein the second plane is at least one of the following: parallel to the first plane; orthogonal to the first plane; or non-orthogonal to the first plane.

19. The welding device of claim 18, further comprising:
the first movement corresponds to the type of the welding operation; and
the second movement corresponds to the polarity for the power output for the type of the welding operation

20. A welding device, that includes:
a motor-driven welder assembly including a motor that is a power source that supplies a power output for the welding device or an equipment electrically coupled to the welding device;
the welding device is configured to perform one or more welding operations, wherein the one or more welding operation is a MIG, a TIG, a stick positive, or an FCAW;
a mechanical lever that is moveable between two or more pre-defined locations, wherein each of the two or more pre-defined locations indicates control settings for the welding device, the control settings are the one or more welding operations, the power output for the one or more welding operations, and a polarity for the power output for the one or more welding operations; and
a user interface, on an exterior surface of the welding device, that is configured to convey data and includes a label for each of the two or more pre-defined locations, wherein the label conveys the one or more welding operations, the power output for the one or more welding operations, and the polarity for the power output for the one or more welding operations.
